(19) United States
(12) Patent Application Publication
(10) Pub. No.: US 2005/0092441 A1
(43) Pub. Date: May 5, 2005

(54) Two-in-one handheld drywall mud/drywall tape dispenser device

(76) Inventor: Jason Lee Pfefferkorn, Ramah, CO (US)

Correspondence Address: LAW OFFICE OF DALE B. HALLING, 24 s. WEBER ST., SUITE 311, COLORADO SPRINGS, CO, 80903, US

(21) Appl. No.: 10/974,635

(22) Filed: Oct. 27, 2004

Related U.S. Application Data
(60) Provisional application No. 60/517,001, filed on Nov. 4, 2003.

(51) Int. Cl. B44C 7/00

(52) U.S. Cl. 156/574; 156/577

(57) ABSTRACT

A drywall mud and drywall tape dispenser includes a one-piece mud tray for holding a quantity of drywall mud. The tray includes a tape inlet and a tape outlet. A drywall tape holder is removably attached to an end of the tray. A roll of drywall tape is placed into the tape holder and threaded through the tape inlet and tape outlet and the tray is filled with drywall mud. The drywall tape is coated with drywall mud as it is drawn through the mud-filled tray. The tray may be used independently from the tape holder. A cutting groove is attached to the tray so that tape can be cut with a common tape knife.

### PRIORITY DATA

This application claims benefit of U.S. Provisional Patent Application Ser. No. 60/517,001 filed on Nov. 4, 2003.

### BACKGROUND OF THE INVENTION

1. Field of the Invention

The present invention relates to drywall mud and drywall tape dispensing devices. In particular, the present invention relates to a single dispenser for both drywall mud and drywall tape to streamline the drywall repair process.

2. Description of the Related Art

Numerous devices have been developed to simplify the completion of drywall joints. These devices include various powered and pneumatic mud application tools as well as complex, single-purpose tools. The powered and pneumatic devices typically have a mud reservoir with a pump connected to a handheld mud applicator via a hose. The applicator includes a roll of drywall tape. Mud is pumped from the remote reservoir to the handheld applicator under pressure. Switches are requires to start and stop the flow of mud and to measure the rate of the flow at the applicator. These devices are quite expensive, heavy and mechanically complex. They save time for a professional drywall technician, but are quite impractical for small jobs or do-it-yourselfers.

Another group of mud application tools are single-purpose, complex handheld tools. These tools avoid some of the drawbacks of the powered and pneumatic tools, but introduce some new ones. These devices include a drywall tape holder that is permanently attached to the drywall mud reservoir. This increases the device's bulk and weight. Further, they include complex tape support frames with sensitive rollers to transport the tape through the mud. They also have adjustable tape inlet and tape outlet ports. Such supports make the devices much more unwieldy. The rollers and adjustable ports are easily clogged or frozen in place by dried or excessively tacky mud. All these features act to increase their costs of production and maintenance. After the tape is applied, if the user wants to touch-up selected spots or areas with mud, he must carry the entire handheld assembly.

Therefore, there has been and continues to be a need for a simple, rugged drywall tape and drywall mud application device that is flexible in its use and that requires minimal maintenance.

### SUMMARY OF THE DISCLOSURE

The present invention provides a two in one drywall tape and drywall mud dispensing device. The device has no moving or adjustable parts. The device includes a drywall mud tray and a drywall tape holder. The tray includes a tape inlet and a tape outlet so that drywall tape can be drawn through the tray. The tray is filled with mud and the tape is coated with drywall mud as it is drawn through the device. The tape holder is easily separable from the tray to permit the user to more easily carry and use the tray for applying mud when taping is completed. An integral cutting guide adjacent to the tape outlet allows a user to cut the drywall tape cleanly and easily with a handheld taping knife. The user may coat one or both sides of drywall tape with mud.

### BRIEF DESCRIPTION OF THE DRAWINGS

FIG. 1 is a perspective view of an embodiment of the drywall tape and drywall mud applicator in accordance with the present invention;

FIG. 2 is a perspective view of an embodiment of the drywall tape and drywall mud applicator in accordance with the present invention;

FIG. 3 is a side view of the drywall tape and drywall mud applicator in accordance with the present invention; and

FIG. 4 is a side view of the drywall tape and drywall mud applicator in accordance with the present invention.

### DETAILED DESCRIPTION OF THE DRAWINGS

The following detailed description is of the best presently contemplated modes of carrying out the invention. This description is not to be taken in a limiting sense, but is made merely for the purpose of illustrating general principles of embodiments of the invention.

The present invention provides a two in one drywall tape and drywall mud dispensing device. The device has no moving or adjustable parts. The device includes a drywall mud tray and a drywall tape holder. Tape is coated with drywall mud as it is drawn through the device. The tape holder is easily separable from the tray to permit the user to more easily carry and use the tray for applying mud when taping is completed. A built-in cutting guide allows a user to cut the drywall tape cleanly and easily with a handheld taping knife.

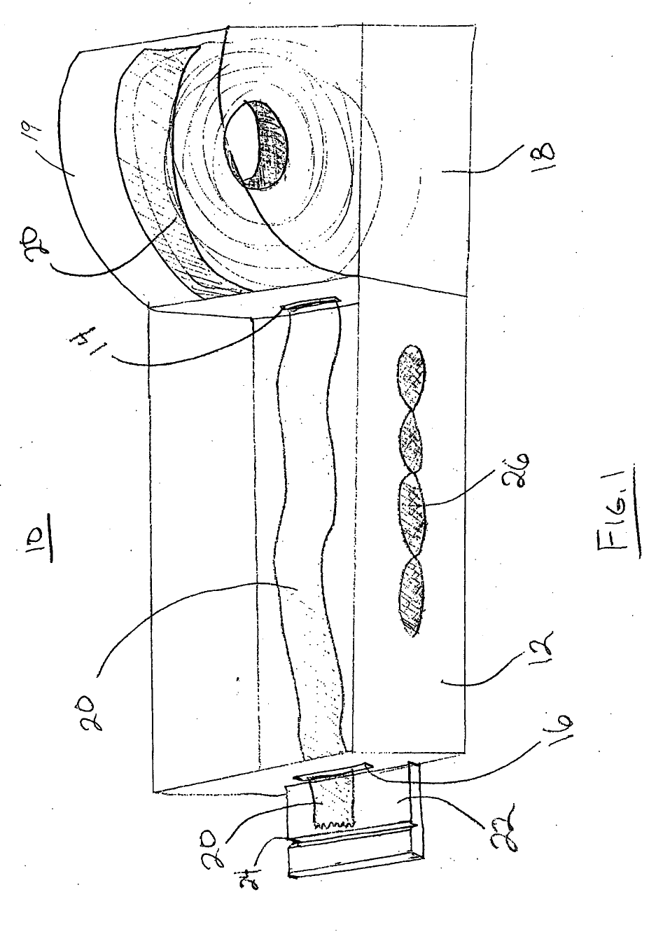

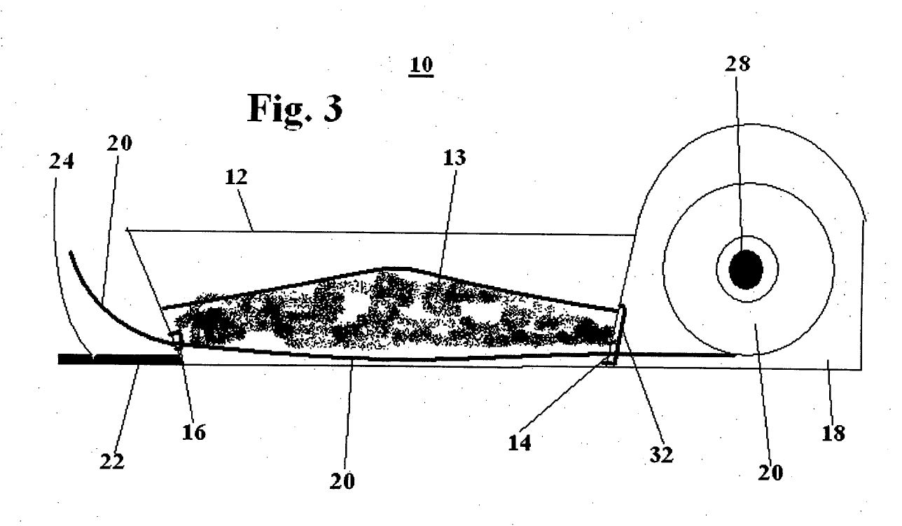

FIG. 1 shows a drywall mud and drywall tape dispenser 10 having a one-piece mud tray 12. The tray 12 has a tape inlet 14 and a tape outlet 16 incorporated into opposite ends. In the preferred embodiment, the tray 12 is made from a single piece and has no moving parts. The tray 12 may be stamped from metal sheet or molded from a plastic material. The tape inlet 14 and tape outlet 16 are formed into the tray 12 and are not adjustable. The single-piece design of the tray 12 and non-adjustability of the inlet 14 and outlet 16 simplifies the manufacturing and maintenance of the device. A drywall tape holder 18 is removably attached to the tape inlet 14 end of the tray 12. Drywall tape 20 is placed into the tape holder 18 and threaded through the tape inlet 14 and tape outlet 16 as shown. The drywall tape holder 18 may be open-topped or have a lid 19. In the case of an open-topped tape holder 18, a spindle 28 (see FIG. 3) may be used to secure a roll of drywall tape 20 into the holder 18. In the case where the holder 18 includes a lid 19, the lid 19 may be secured to the holder 18 via friction or an interlocking fit. A transparent lid 19 enables the user to monitor the drywall tape 20 and know when it is running low.

A platform 22 is attached to tape outlet end 16 of the tray 12, adjacent to the tape outlet 16. A cutting groove 24 is incorporated into the platform 22. The cutting groove 24 accepts a standard handheld taping knife. The user draws the desired length of drywall tape 20 through the dispenser 10 and pins the tape 20 to the platform with his taping knife. The user then pulls the tape 20 to tear it cleanly against the knife. The use of the handheld taping knife eliminates a difficult-to-clean blade fixed to the tray 12, and simplifies the dispenser's manufacture, use and cleaning. The use of a standard, handheld taping knife also improves safety.

In another embodiment, the tray 12 includes a pair of handgrips 26 incorporated into the sides of the tray 12. The handgrips 26 are preferably attached to the tray 12 on the closest pair of opposing sides. This improves the handling qualities of the dispenser 10. The handgrips 26 are preferably integrally formed into the tray 12 to simplify the manufacturing process and eliminate moving parts. The handgrips 26 may be a raised or inset textured surface or finger grooves that improve the user's purchase on the dispenser 10.

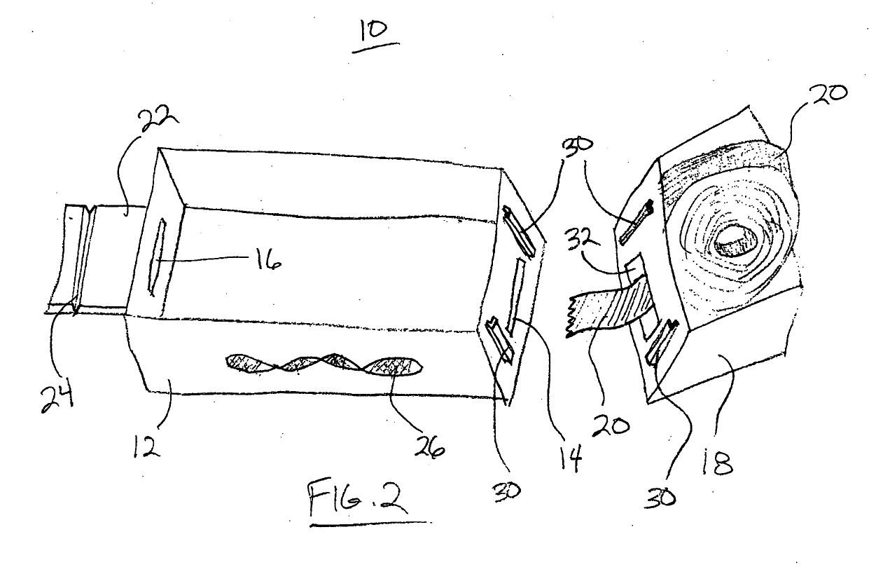

FIG. 2 shows the drywall mud and drywall tape dispenser 10 separated into its two major components, the one-piece tray 12 and the tape holder 18. The tray 12 and the holder 18 are attached together via a tongue and groove or interlocking channel mechanism 30. The interlocking channel mechanism 30 is incorporated into outside of the tape inlet end of the tray 12 and the mating side of the tape holder 18. As is shown, the tape holder 18 includes an aperture 32. The aperture 32 permits the tape 20 to exit the holder 18 and enter the tray 12 through the tape inlet 14.

The tape inlet 14 is just large enough to admit a single layer of drywall tape 20. The tape outlet 16 is slightly larger than the tape inlet 14, to accommodate the tape 20 when it is coated with drywall mud 13. Neither the tape inlet 14 nor the tape outlet 16 are adjustable. The tape outlet 16 may have different shapes. The outlet 16 may be a regular rectangle with straight sides and edges, an ovoid aperture to permit more mud to adhere to the center of the tape 20, or it may have scalloped or serrated edges to closely regulate the amount of mud coated onto the tape 20.

The tray 12 is easily separated from the tape holder 18 when the user is finished applying tape 20. A separate, standard mud tray is not necessary. The tray 12 may be used as a standard mud tray to finish the remainder of the drywall job. When the workday or job is complete, the entire dispenser 10 can be immersed in water for quick and easy cleaning.

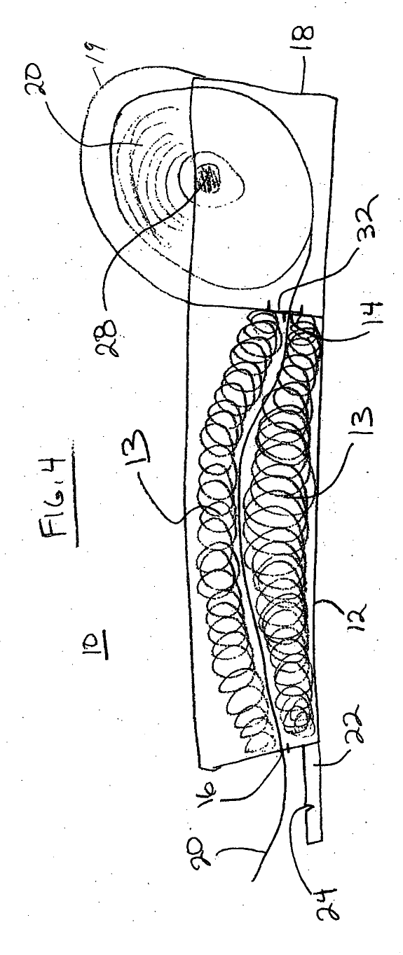

FIGS. 3 and 4 show alternate uses of the drywall tape and mud dispenser 10. FIG. 3 shows a dispenser 10 that coats one side of the tape 20 with mud 13. To accomplish this, the tape 20 is routed through the tray 12, and mud 13 is placed atop the tape 20. The tape 20 is thus in contact with the mud 13. The top surface of the tape 20 drawn from the tray 12 through the tape outlet 16 is coated with mud 13 on one side. In an alternative embodiment, the tape 20 is routed over the top of the mud 13 in the tray 12 so that the mud 13 coats only the lower surface of the tape 20.

Loading the dispenser 10 may be done in a few simple steps: first the tape 20 is routed from the tape holder 18, through the inlet 14, and through the tape outlet 16. Next, a quantity of mud 13 is placed into the tray 12 atop the tape 20.

FIG. 4 shows a dispenser that coats both sides of the tape 20 with mud 13. The loading process is similar to the process described in FIG. 3, with the addition of one last step: after the tape 20 is routed from the tape holder 18, through the inlet 14, over the mud 13 and through the tape outlet 16, an additional layer of mud 13 is placed on top of the tape 20 so that the tape 20 is enveloped within the mud 13. In this manner, the user can easily and selectively coat one or both sides of the tape 20 for application to a drywall joint.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

1. A drywall mud and drywall tape dispenser, comprising:
a one-piece mud tray for holding a quantity of drywall mud, having a tape inlet and a tape outlet; and
a drywall tape holder removably attached to an end of the tray.

2. The drywall mud and drywall tape dispenser as set forth in claim 1, further comprising a platform attached to the tray adjacent to the tape outlet.

3. The drywall mud and drywall tape dispenser as set forth in claim 2, where the platform comprises a cutting guide incorporated into a top side of the platform.

4. The drywall mud and drywall tape dispenser as set forth in claim 1, further comprising a pair of grip panels fixed to the tray, one grip panel attached to each long side wall adjacent to the floor panel.

5. The drywall mud and drywall tape dispenser as set forth in claim 1, where the tape inlet is just large enough to permit a single layer of drywall tape to pass.

6. The drywall mud and drywall tape dispenser as set forth in claim 1, where the tape outlet is just large enough to permit a single layer of drywall tape coated with drywall mud to pass.

7. The drywall mud and drywall tape dispenser as set forth in claim 1, where the dispenser coats one side of the drywall tape with drywall mud.

8. The drywall mud and drywall tape dispenser as set forth in claim 1, where the dispenser coats both sides of the drywall tape with drywall mud.

9. A drywall mud and drywall tape dispenser, comprising:
a one-piece mud tray for holding a quantity of drywall mud, having a tape inlet and a tape outlet; and
a drywall tape holder attached to an end of the tray.

10. The drywall mud and drywall tape dispenser of claim 9, where the drywall tape holder is removably attached to the one-piece mud tray.

11. The drywall mud and drywall tape dispenser as set forth in claim 9, further comprising a platform attached to the tray adjacent to the tape outlet.

12. The drywall mud and drywall tape dispenser as set forth in claim 11, where the platform comprises a cutting guide incorporated into a top side of the platform.

13. The drywall mud and drywall tape dispenser as set forth in claim 9, further comprising a pair of grip panels fixed to the tray, one grip panel attached to each long side wall adjacent to the floor panel.

14. The drywall mud and drywall tape dispenser as set forth in claim 9, where the dispenser coats both sides of the drywall tape with drywall mud.

15. A drywall mud and drywall tape dispenser, comprising:
a mud tray for holding a quantity of drywall mud, having a tape inlet and a tape outlet; and
a drywall tape holder removably attached to an end of the tray.

16. The drywall mud and drywall tape dispenser of claim 15, where the mud tray is made as a single piece with no moving parts.

17. The drywall mud and drywall tape dispenser as set forth in claim 15, further comprising a platform attached to the tray adjacent to the tape outlet.

18. The drywall mud and drywall tape dispenser as set forth in claim 17, where the platform comprises a cutting guide incorporated into a top side of the platform.

19. The drywall mud and drywall tape dispenser as set forth in claim 15 further comprising a pair of grip panels fixed to the tray, one grip panel attached to each long side wall adjacent to the floor panel.

20. The drywall mud and drywall tape dispenser as set forth in claim 15 where the dispenser coats both sides of the drywall tape with drywall mud.
